(19) United States
(12) Patent Application Publication
(10) Pub. No.: US 2021/0080016 A1
(43) Pub. Date: Mar. 18, 2021

(54) SIX-WAY HYDRAULIC PROPORTIONAL VALVE

(71) Applicant: NIO USA, Inc., San Jose, CA (US)

(72) Inventor: Ming Fung Wong, San Jose, CA (US)

(21) Appl. No.: 16/569,347

(22) Filed: Sep. 12, 2019

(51) Int. Cl. F16K 11/085; F16K 11/06; F16K 3/24; F01P 3/12

(52) U.S. Cl. CPC F16K 11/0853; F01P 3/12; F16K 3/243; F16K 11/06

(57) ABSTRACT

A valve comprising two rotors, each rotor comprising two passageways and two or more sealing faces. The valve allows for controlling air flow between six directions. The valve can operate in a number of operation modes depending on a position of the rotors. The valve design can include a valve-housing with six ports. Two rotary valves provide a plurality of predetermined flow modes between the six ports.

### FIELD OF INVENTION

The present invention relates generally to directing flows and, more particularly, to an apparatus for efficiently directing flows of fluids in an electric vehicle.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new flexible-fuel vehicles, hybrid-electric vehicles, and electric vehicles.

Valves are devices that regulate, direct, and/or control the flow of a fluid such as a gas, liquid, fluidized solid, etc. While traditional valves may operate with two ports and allowed controlling a rate of flow through a single passageway, modern technology demands valves with a greater number of ports allowing for a plurality of configurations of flows.

Rotary valves may be used to direct flow to and from a number of peripheral ports spaced around the valve. Rotary valves may comprise a stator plate and a rotor plate. Typically, a rotor plate is maintained in fluid-tight contact with the stator plate and is operable to rotate within the stator. A flow may be established into one of the peripheral ports, through the rotor plate, and out of another peripheral port.

A modern electric vehicle requires flows of coolant throughout the vehicle. Maintaining flows throughout the vehicle requires a number of valves interconnected with a number of elements. What is needed is an apparatus capable of reducing the number of valves needed for efficient flow of fluid throughout a vehicle.

### BRIEF DESCRIPTION OF THE DRAWINGS

FIG. 1 is a perspective view of a valve in accordance with some embodiments of the invention;

FIG. 2 is a perspective view of a valve in accordance with some embodiments of the invention;

FIG. 3 is a top cross-sectional view of a valve in accordance with some embodiments of the invention;

FIGS. 4A-J are mode diagrams in accordance with some embodiments of the invention;

FIGS. 5-14 are top cross-sectional views of a valve in accordance with some embodiments of the invention;

FIG. 15 is a block diagram showing a vehicle and network of valves in accordance with some embodiments of the invention;

FIG. 16 is a perspective view of a valve housing in accordance with some embodiments of the invention;

FIG. 17 is a perspective view of a valve housing in accordance with some embodiments of the invention;

FIGS. 18A and 18B are perspective views of valve rotors in accordance with some embodiments of the invention;

FIGS. 19A and 19B are illustration of rotor designs in accordance with some embodiments of the invention;

FIG. 20A is an illustration of a portion of a two-rotor valve in accordance with some embodiments of the invention;

FIG. 20B illustrates possible positions for a rotor of a two-rotor valve in accordance with some embodiments of the invention;

FIG. 21A is a perspective view of a two-rotor valve in accordance with some embodiments of the invention;

FIG. 21B illustrates possible positions for a two-rotor valve in accordance with some embodiments of the invention;

FIGS. 22A-L illustrate possible positions for one rotor of a two-rotor valve in accordance with some embodiments of the invention;

FIG. 23 is a chart illustrating hub positions and port communication for a two-rotor valve in accordance with some embodiments of the invention; and

FIG. 24 is a table illustrating hub positions and port communication for a two-rotor valve in accordance with some embodiments of the invention.

### DETAILED DESCRIPTION

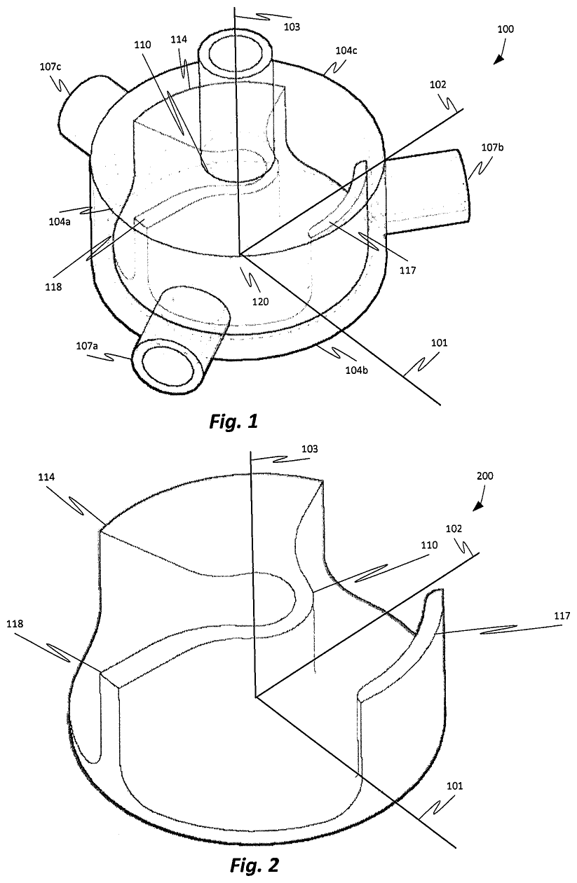

As illustrated in FIG. 1, and in an alternative angle view in FIG. 2, a rotary valve 100 may comprise an outer wall 104a-c and a rotatable inner mechanism (114, 117, 118). For purposes of illustration, the valve 100 is shown on a three-dimensional axis, with an x-axis 101, a y-axis 102, and a vertical, or z, axis 103. The rotatable inner mechanism (114, 117, 118), may rotate around the vertical axis 103. The outer wall 104a-c may comprise three ports 107a, b, c facing horizontally outward from the center of the valve 100. The valve 100 may further comprise a fourth port 110 facing in a vertical direction at a ninety-degree angle from the three other ports 107a, b, c. Note that neither this figure or any other figure is necessarily drawn to scale and the dimensions of various elements and the interrelated position of various elements may vary in some embodiments.

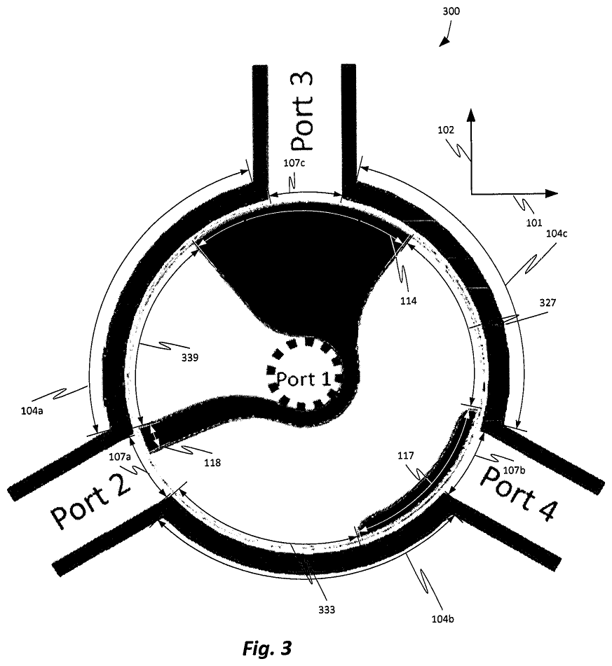

The rotatable inner mechanism (114, 117, 118) of the rotary valve 100, may comprise three portions 114, 117, 118. The portions may be connected to each other via a top element and/or a bottom element. A top down perspective view is shown in FIG. 3.

As can be appreciated, a first portion 114 of the rotatable inner mechanism (114, 117, 118) may extend from an outer wall of the vertical port 110 toward an inner edge of the outer wall 104a-c of the rotary valve 100. As illustrated in FIG. 3, the portion 114 may cover around 80 degrees of the inner edge of the outer wall 104a-c. The portion 114 of the rotatable inner mechanism (114, 117, 118) may be connected to the outer wall of the vertical port 110 (Port 1 of FIG. 3).

A second portion 118 of the rotatable inner mechanism may also connect to the outer wall of the vertical port 110 and extend outward toward an inner edge of the outer wall 104a-c of the rotary valve 100. As illustrated in FIG. 3, the portion 118 may cover around 13 degrees of the inner edge of the outer wall 104a-c.

A third portion 117 of the rotatable inner mechanism (114, 117, 118) may be positioned along the outer wall 104a-c of the rotary valve 100. As illustrated in the figures, the third portion 117 may extend away from the outer wall 104a-c slightly while leaving an open area or gap between the outer wall of the vertical port 110. The third portion 117 may cover around 43 degrees of the inner edge of the outer wall 104a-c.

The first portion 114 and the second portion 118 may be separated by an open area or gap 339. Gap 339 may be connected to the vertical port 110 such that a fluid may be able to flow between gap 339 and the vertical port 110. The gap 339 may cover around 80 degrees of the inner edge of the outer wall 104a-c as illustrated in FIG. 3. Depending on a position of the rotatable inner mechanism (114, 117, 118), the gap 339 may allow air or fluid to pass to and from the vertical port 110 and one of the three horizontal ports 107a-c. For example, in the position shown in FIG. 3,

The second portion 118 and the third portion 117 may be separated by an open area or gap 333. Gap 333 may cover around 64 degrees of the inner edge of the outer wall 104a-c. The third portion 117 and the first portion 114 may be separated by an open area or gap 327. Gap 327 may cover around 80 degrees of the inner edge of the outer wall 104a-c. Gaps 333 and 327 may be connected such that a passageway is formed in which fluid may be able to flow between the gaps 333 and 327. Depending on a position of the rotatable inner mechanism (114, 117, 118), each of gaps 333 and 327 may connect with a different one of ports 107a, b, c and the passageway connecting the gaps 333 and 327 may allow fluid to pass between those two ports.

The three ports 107a-c or openings may be positioned along the outer wall 104a-c. While the ports 107a-c in the figures appear to be circular in shape, in some embodiments the ports may be circular or any other shape.

The inner rotatable mechanism may be controlled by a servomotor controlled by a processor onboard the vehicle. The angular position of the inner rotatable mechanism may be determined by an angular position sensor. The servomotor may be connected to a shaft connected to the rotor at a junction 120.

While the figures show the rotary valve 100 to be open on the upper portion of the vertical axis, this is for illustration purposes only. The valve may be sealed by a housing, as illustrated in FIG. 16, such that air or fluid may pass only through the four ports. Air or fluids may be capable of passing between ports dependent on a position of the rotatable inner mechanism.

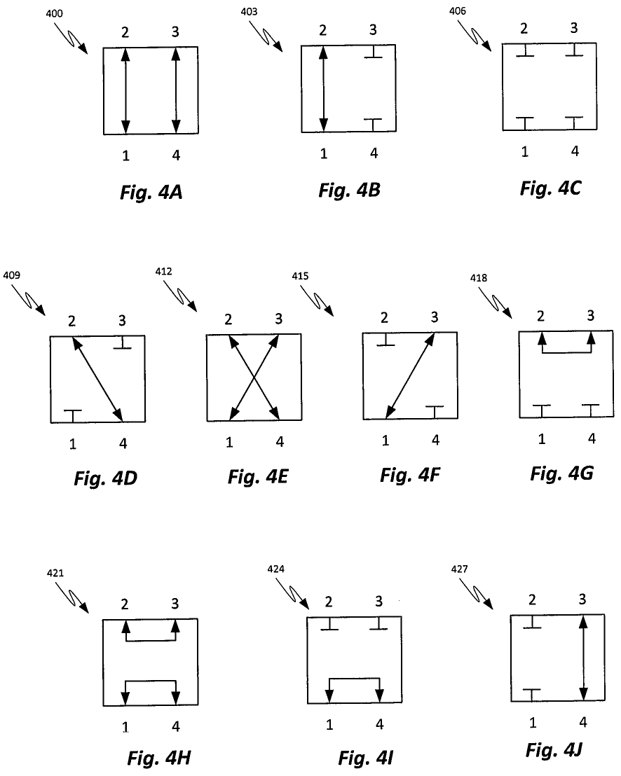

Depending on a position of the rotatable inner mechanism (114, 117, 118), fluid may be able to be passed between the ports via two interior passageways in a number of configurations. As illustrated in FIGS. 4A-J, various flow configurations may be enabled. In FIGS. 4A-J, [1] may represent the vertical port (Port 1 of FIG. 3), while [2] may represent Port 2 of FIG. 3, [3] may represent Port 3 of FIGS. 3 and [4] may represent Port 4 of FIG. 3. Arrows between the ports may represent a flow while the T shape may represent a blocked port. As can be appreciated from FIGS. 4A-J, at least ten flow configurations may be achieved via the angular position of the rotatable inner mechanism of the valve. These configurations are illustrated in further detail below.

As explained herein, a first passageway 509 may always be connected to a vertical port 512 while a second passageway 515 may never connect to the vertical port 512. On an end of the first passageway 509 that is away from the vertical port 512 the first passageway 509 may comprise a first gap 524. The first gap 524 when aligned with one of the three horizontal ports 521, 527, 533 may allow for a flow of fluid from the vertical port 512 to the one of the three horizontal ports 521, 527, 533. A second passageway 515 may be a route running through the valve in a horizontal plane. The second passageway 515 may have two gaps 524, 530. The two gaps 524, 530 of the second passageway 515 may be capable of aligning with up to two of the three horizontal ports 521, 527, 533 depending on a rotational position of the rotatable inner rotor.

The first passageway 509 and the second passageway 515 may be physically connected to each other by three solid portions 536, 539, 542. The three solid portions 536, 539, 542 may act as flow blockers and be capable of sealing off flow into/out of the three horizontal ports 521, 527, 533. The three solid portions 536, 539, 542 may comprise a first flow blocker 536, a second flow blocker 539, and a third flow blocker 542. As explained below, the first passageway 509, the second passageway 515, the first flow blocker 536, the second flow blocker 539, and the third flow blocker 542 may all be interconnected pieces of the inner rotatable rotor and may rotate together to switch flow into and out of the four ports

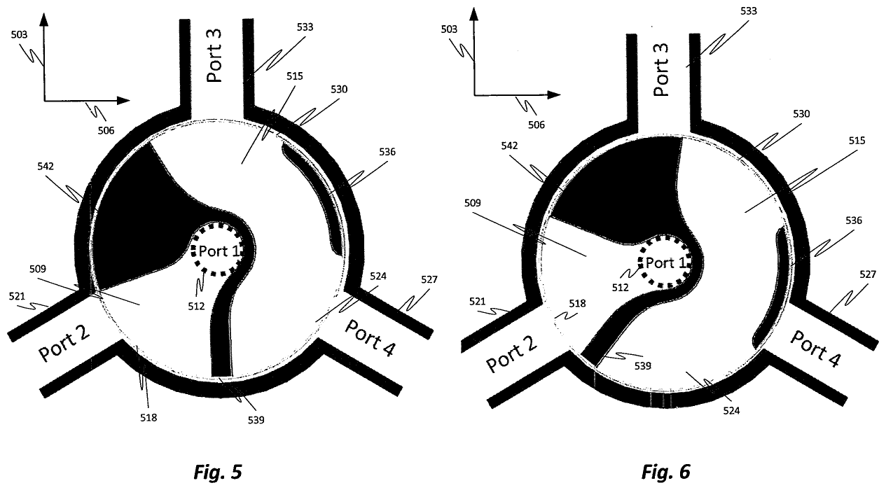

As illustrated in FIG. 4A, in a first mode 400, the first port may be connected to the second port and the third port may be connected to the fourth port. This configuration is illustrated in a top down perspective view in FIG. 5. As can be appreciated from FIG. 5, the first mode 400 allows for two parallel flows, a first flow from port one to port two and a second flow from port three to port four. Flows between two ports should not be interpreted as being limited to being in a single direction. A statement that a flow is from a first port to a second port may also include the flow being from the second port to the first port.

In the embodiment illustrated in FIG. 5, the inner rotatable rotor is aligned to a rotational position such that the first passageway 509 is positioned such that the gap 518 of the first passageway 509 is aligned with the second port 521 while the second passageway 515 is positioned such that the first gap 524 of the second passageway 515 is aligned with the fourth port 527 and the second gap 530 of the second passageway 515 is aligned with the third port 533. With the inner rotatable rotor in such a position, a flow between the first port 512 and the second port 521 through the first passageway 509 and a flow between the third port 533 and the fourth port 527 through the second passageway 515 may be achieved.

As illustrated in FIG. 4B, in a second mode 403, the first port may be connected to the second port and the third and fourth port may be blocked. This configuration is illustrated in FIG. 6.

In the embodiment illustrated in FIG. 6, the inner rotatable rotor is aligned to a rotational position such that the first passageway 509 is positioned such that the gap 518 of the first passageway 509 is aligned with the second port 521 while the second passageway 515 is positioned such that the first gap 524 and the second gap 530 of the second passageway 515 are not aligned with any of the three horizontal ports 521, 527, 533. With the inner rotatable rotor in such a position, a flow between the first port 512 and the second port 521 through the first passageway 509 is achieved while flow to and from the third port 533 and flow to and from the fourth port 527 is blocked.

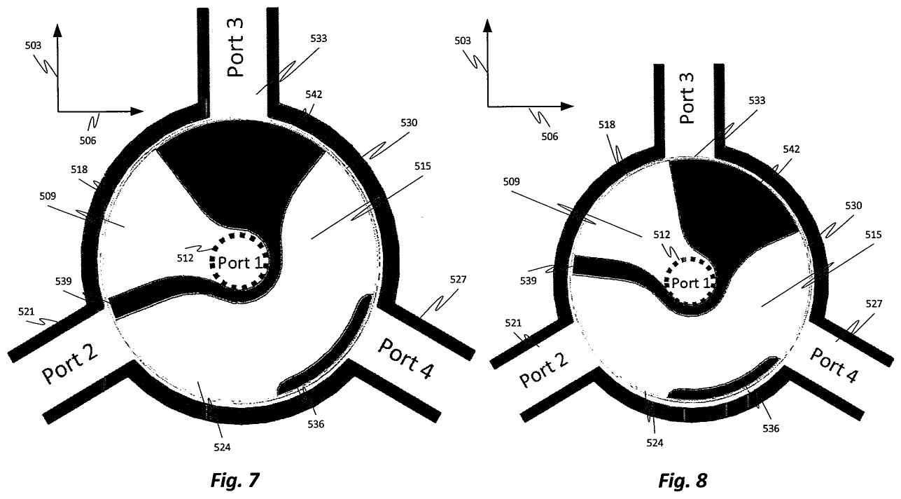

As illustrated in FIG. 4C, in a third mode 406, each of the four ports may be blocked such that no flow is allowed into or out of the valve. This configuration is illustrated in FIG. 7.

In the embodiment illustrated in FIG. 7, the inner rotatable rotor is aligned to a rotational position such that the first passageway 509 is positioned such that the gap 518 of the first passageway 509 is aligned with the inner wall of the valve between the second port 521 and the third port while the second passageway 515 is positioned such that the fourth port 527 is blocked. With the inner rotatable rotor in such a position, flow to and from the first port 512, second port 521, third port 533, and fourth port 527 is blocked.

As illustrated in FIG. 4D, in a fourth mode 409, the first and third ports may be blocked, and the second port may be connected to the fourth port. This configuration is illustrated in FIG. 8.

In the embodiment illustrated in FIG. 8, the inner rotatable rotor is aligned to a rotational position such that the first passageway 509 is positioned such that the gap 518 of the first passageway 509 is aligned with the inner wall of the valve between the second port 521 and the third port while the second passageway 515 is positioned such that the first gap 524 of the second passageway 515 is aligned with the second port 521 and the second gap 530 of the second passageway 515 is aligned with the fourth port 527. With the inner rotatable rotor in such a position, a flow to and from the first port 512 and to and from the third port 533 is blocked while flow between the second port 521 and the fourth port 527 through the second passageway 515 is achieved.

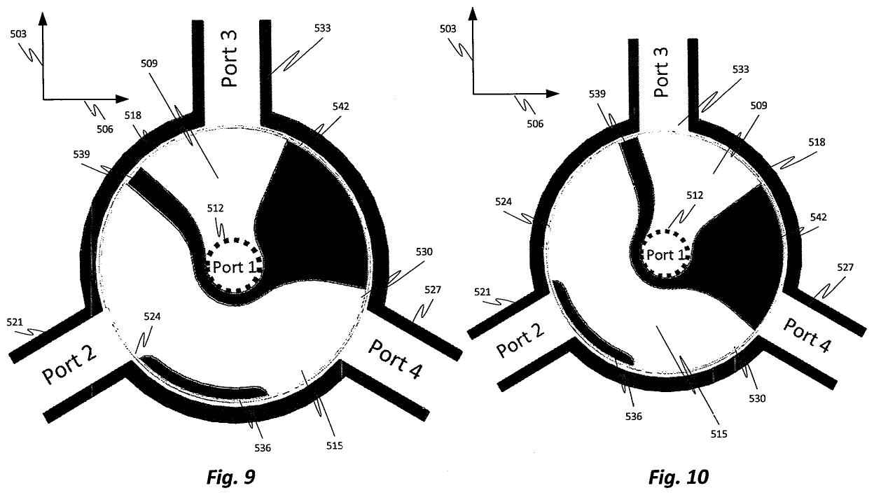

As illustrated in FIG. 4E, in a fifth mode 412, the first port may be connected to the third port and the second port may be connected to the fourth port. This configuration is illustrated in FIG. 9.

In the embodiment illustrated in FIG. 9, the inner rotatable rotor is aligned to a rotational position such that the first passageway 509 is positioned such that the gap 518 of the first passageway 509 is aligned with the third port 533 while the second passageway 515 is positioned such that the first gap 524 of the second passageway 515 is aligned with the third port 533 and the second gap 530 of the second passageway 515 is aligned with the fourth port 527. With the inner rotatable rotor in such a position, a flow between the first port 512 and the third port 533 through the first passageway 509 and a flow between the second port 521 and the fourth port 527 through the second passageway 515 may be achieved.

As illustrated in FIG. 4F, in a sixth mode 415, the first port may be connected to the third port and the second and fourth ports may be blocked. This configuration is illustrated in FIG. 10.

In the embodiment illustrated in FIG. 10, the inner rotatable rotor is aligned to a rotational position such that the first passageway 509 is positioned such that the gap 518 of the first passageway 509 is aligned with the third port 533 while the second passageway 515 is positioned such that the third port 533 is blocked by a blocking face 536 between the two gaps 527, 530 of the second passageway 515. With the inner rotatable rotor in such a position, a flow between the first port 512 and the third port 533 through the first passageway 509 is achieved while no flow is allowed to and from the second port 521 and fourth port 527.

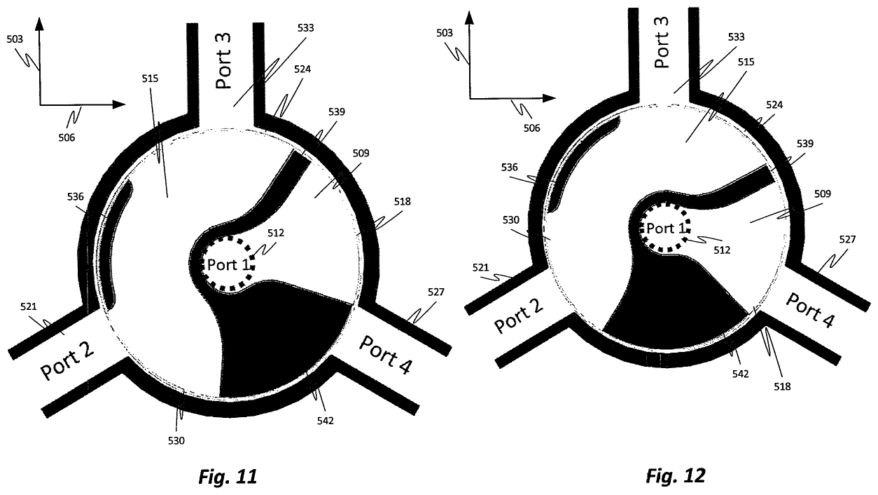

As illustrated in FIG. 4G, in a seventh mode 418, the second port may be connected to the third port and the first and fourth ports may be blocked. This configuration is illustrated in FIG. 11.

In the embodiment illustrated in FIG. 11, the inner rotatable rotor is aligned to a rotational position such that the first passageway 509 is positioned such that the gap 518 of the first passageway 509 is aligned with the inner wall of the valve between the third port 533 and the fourth port while the second passageway 515 is positioned such that the first gap 524 of the second passageway 515 is aligned with the second port 521 and the second gap 530 of the second passageway 515 is aligned with the third port 533. With the inner rotatable rotor in such a position, a flow to and from the first port 512 and to and from the fourth port 527 is blocked while flow between the second port 521 and the third port 533 through the second passageway 515 is achieved.

As illustrated in FIG. 4H, in an eighth mode 421, the first port may be connected to the fourth port and the second port may be connected to the third port. This configuration is illustrated in FIG. 12.

In the embodiment illustrated in FIG. 12, the inner rotatable rotor is aligned to a rotational position such that the first passageway 509 is positioned such that the gap 518 of the first passageway 509 is aligned with the fourth port 527 while the second passageway 515 is positioned such that the first gap 524 of the second passageway 515 is aligned with the second port 521 and the second gap 530 of the second passageway 515 is aligned with the third port 533. With the inner rotatable rotor in such a position, a flow between the first port 512 and the fourth port 527 through the first passageway 509 and a flow between the second port 521 and the third port 533 through the second passageway 515 may be achieved.

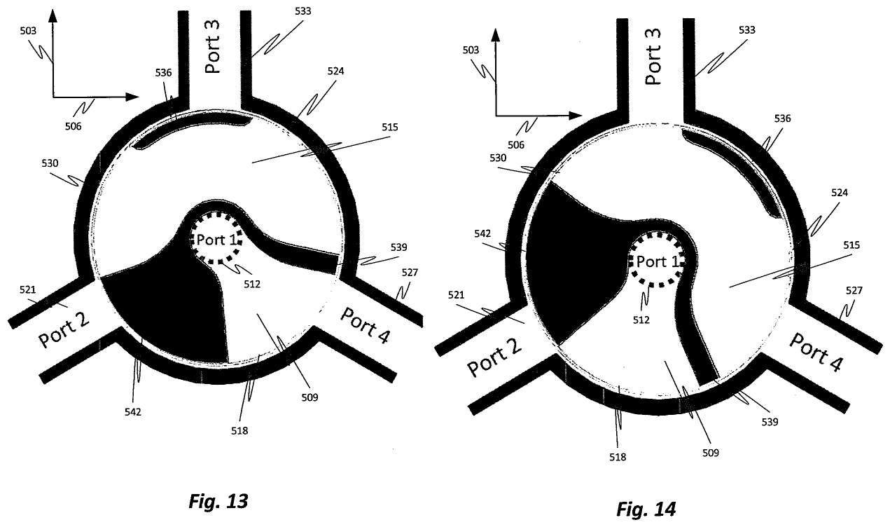

As illustrated in FIG. 4I, in a ninth mode 424, the first port may be connected to the fourth port and the second and third ports may be blocked. This configuration is illustrated in FIG. 13.

In the embodiment illustrated in FIG. 13, the inner rotatable rotor is aligned to a rotational position such that the first passageway 509 is positioned such that the gap 518 of the first passageway 509 is aligned with the fourth port 527 while the second passageway 515 is positioned such that the third port 533 is blocked by a blocking face 536 between the two gaps 524, 530 of the second passageway 515. With the inner rotatable rotor in such a position, a flow between the first port 512 and the fourth port 527 through the first passageway 509 is achieved while no flow is possible to and from the second port 521 and third port 533.

As illustrated in FIG. 4J, in a tenth mode 427, the first and second ports may be blocked while the third and fourth ports may be connected to allow the flow of fluid. This configuration is illustrated in FIG. 14.

In the embodiment illustrated in FIG. 14, the inner rotatable rotor is aligned to a rotational position such that the first passageway 509 is positioned such that the gap 518 of the first passageway 509 is aligned with the inner wall of the valve between the second port 521 and the fourth port 527 while the second passageway 515 is positioned such that the first gap 524 of the second passageway 515 is aligned with the fourth port 527 and the second gap 530 of the second passageway 515 is aligned with the third port 533. With the inner rotatable rotor in such a position, a flow to and from the first port 512 and to and from the second port 521 is blocked while flow between the third port 533 and the fourth port 527 through the second passageway 515 is achieved.

As can be appreciated, a single rotary valve as described above may quickly switch between the ten modes by revolving the inner rotatable mechanism. The valve may operate to switch between modes at a virtually instantaneous rate. The valve may be capable of switching between parallel flows to cross-flows to a total shut-off to partial shut-off of flows depending on the rotational position of the inner rotatable mechanism.

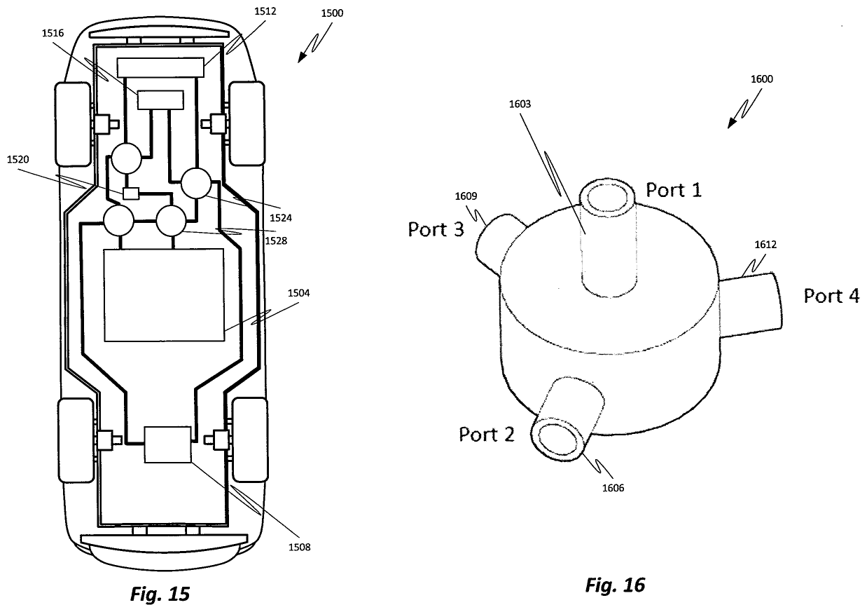

As illustrated in FIG. 15, multiple valves as described herein may be used in conjunction with each other to achieve a great number of configurations. Such a network of valves may be used to distribute coolant or other fluids throughout a vehicle. As can be appreciated in FIG. 15, a vehicle 1500 may comprise a battery 1504, a traction inverter and motor 1508, a radiator 1512, a wireless charger pad and rectifier 1516, and a heater core 1520. For operation of the vehicle 1500, coolant may be needed to be pumped to and from each of such elements. At certain moments the coolant may be needed to be directed to different elements at different times. Using conventional valves, which are capable of fewer configurations as compared to the valve as disclosed herein, a large number of valves, connections, and tubes may be necessary to properly route coolant throughout the vehicle. With valves as described herein, however, the number of valves, connections, and tubes necessary to properly route coolant throughout the vehicle may be reduced.

For example, a first valve 1524 may comprise four ports. The four ports of the first valve 1524 may be connected to a radiator 1512, a wireless charger pad and rectifier 1516, a port of a second valve 1528, and a traction inverter and motor 1508. By controlling a rotational position of an inner rotatable mechanism of the first valve, coolant flowing between the radiator 1512, wireless charger pad and rectifier 1516, port of a second valve 1528, and traction inverter and motor 1508 may be directed. For instance, when the inner rotatable mechanism of the first valve is in a first position, as illustrated in FIG. 7, all flow between the elements may be shutoff. By slightly rotating the inner rotatable mechanism of the first valve to a second position, as illustrated in FIG. 8, flow between two of the elements, for example the traction inverter and motor and the radiator may be achieved while flow into and out of the other two ports remains shut off. By continuing to adjust the rotational position of the inner rotatable mechanism of the first valve, ten different modes may be achieved.

In some embodiments, a valve as described herein may be placed in a housing 1600 as illustrated in FIG. 16. The housing may have four ports 1603, 1606, 1609, 1612, allowing for fluid to pass into and out of the housing 1600 and to be directed by a valve, as described herein, within the housing 1600.

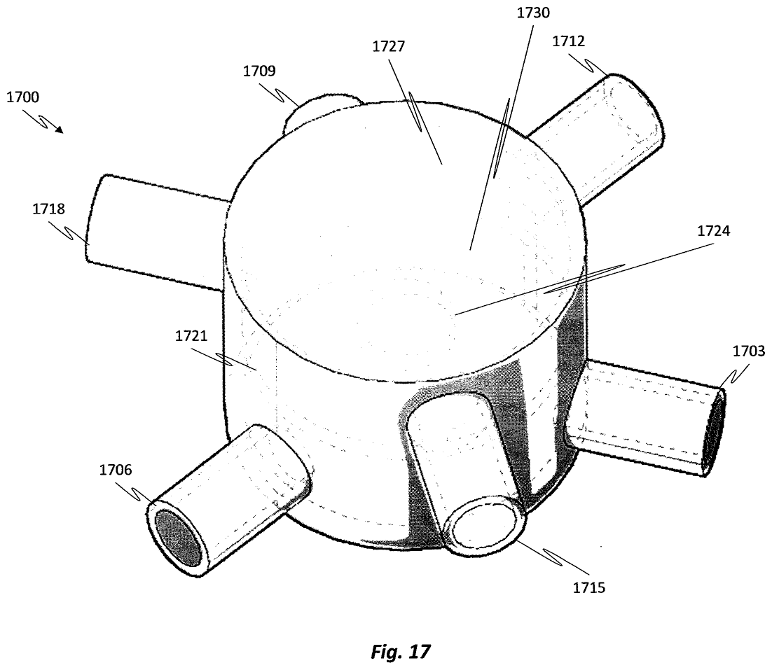

As illustrated in FIG. 17, in some embodiments a two-chamber valve housing 1700 may comprise six ports 1703, 1706, 1709, 1712, 1715, 1718. An interior layer 1721 with an interior port 1724 may separate an upper chamber 1727 of the housing 1700 from a lower chamber 1730 of the housing 1700. Three ports 1703, 1706, 1709 may open into the lower chamber 1730 of the housing 1700. Three ports 1712, 1715, 1718 may open into the upper chamber 1727 of the housing 1700.

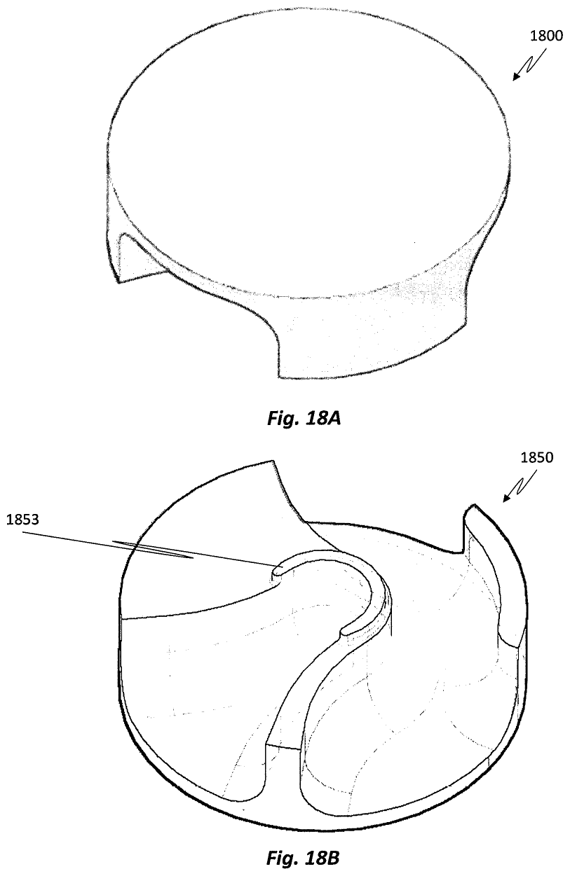

As illustrated in FIGS. 18A and 18B, a two-chamber valve with a housing 1700 as illustrated in FIG. 17 may include two rotors 1800, 1850 (otherwise referred to as hubs). An upper rotor 1800 may be inside the upper chamber 1727 of the housing 1700 and a lower rotor 1850 may be inside the lower chamber 1730 of the housing 1700. The upper rotor 1800 and lower rotor 1850 may be substantially identical. In some embodiments, the upper rotor 1800 may be a mirror reversal of the lower rotor 1850. The upper rotor 1800 and lower rotor 1850 may be the same as or similar to the rotor 200 as illustrated in FIG. 2. The upper and lower rotors 1800, 1850 may in some embodiments include an edge 1853 operable to fit within an interior port 1724 of a two-chamber valve housing 1700 to ensure an air-tight fit.

Each of the upper rotor 1800 and lower rotor 1850 may include two flow pathways. The pathways may be similar to or the same as those described above in relation to the rotor 200 illustrated in FIG. 2. When a two-chamber valve housing 1700 is fitted with an upper rotor 1800 and a lower rotor 1850, air flow may be achieved between a ninety-degree pathway of the lower rotor 1850 and a ninety-degree pathway of the upper rotor 1800 via an interior port 1724. Depending on the angular position of each of the upper and lower rotors 1800, 1850, air flow may be achieved between one of the lower ports 1703, 1706, 1709 and one of the upper ports 1712, 1715, 1718.

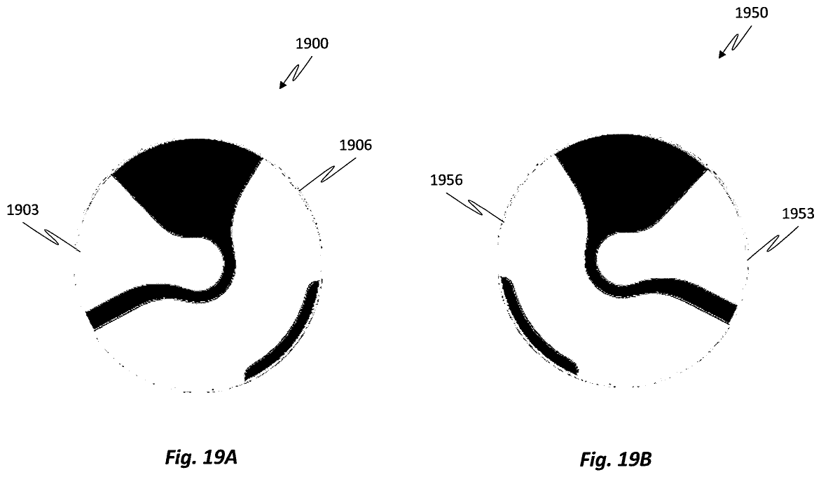

As illustrated in FIG. 19A, a rotor 1900 may include a ninety-degree flow path 1903 and a horizontal flow path 1906. As can be appreciated, the arrangement of the flow paths 1903, 1906 should not be limited to being placed exactly as illustrated. For example, as illustrated in FIG. 19B, in some rotors 1950 the flow pathways 1953, 1956 may be reversed.

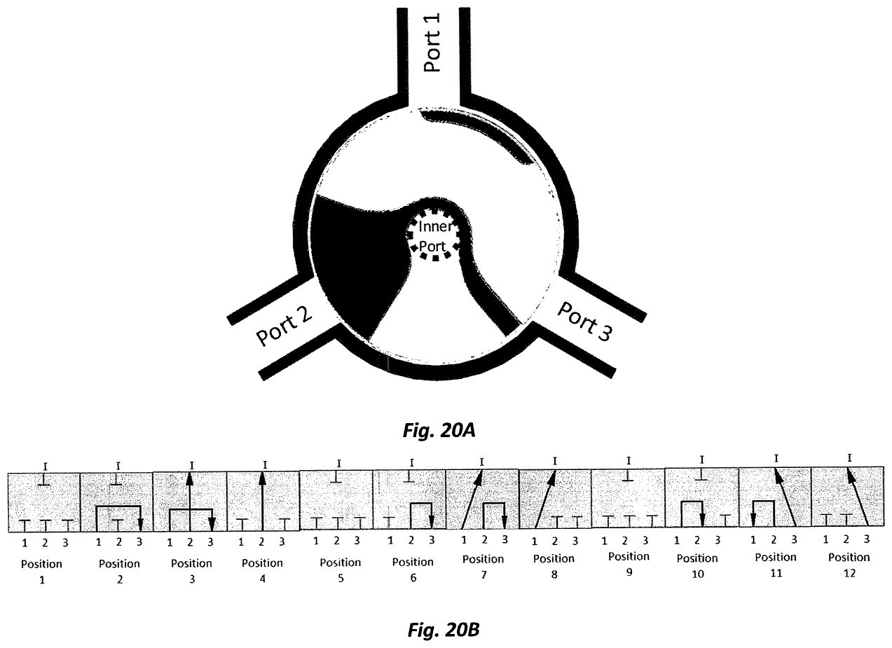

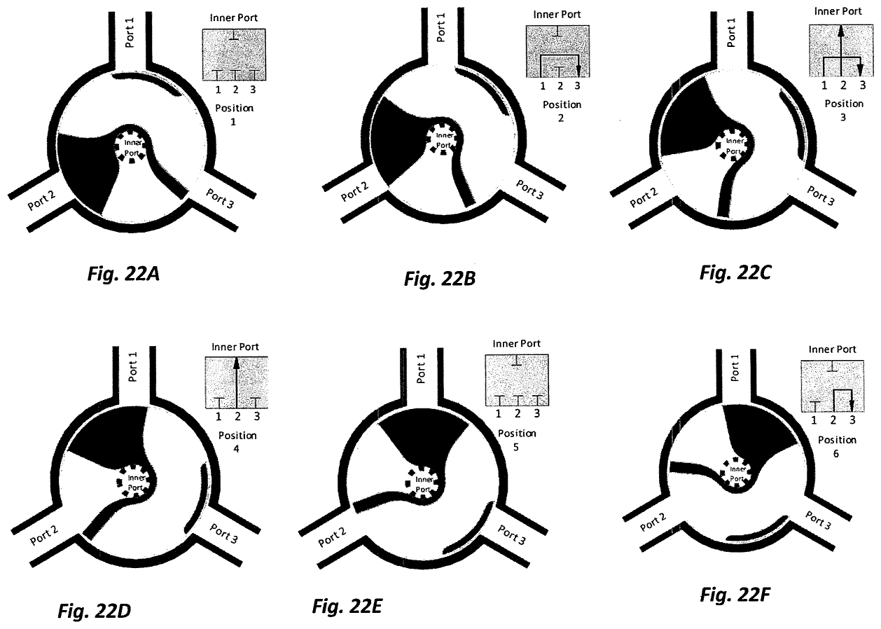

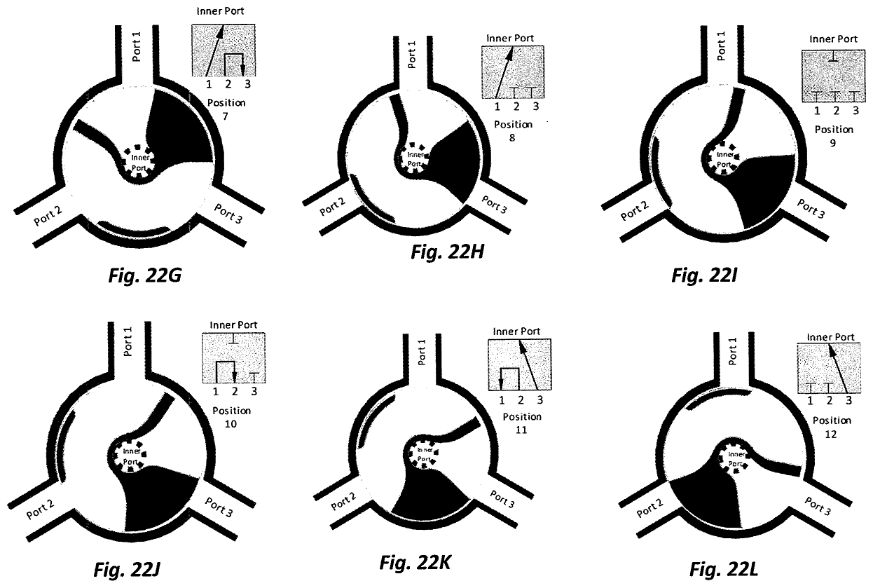

By including a pathway from a port to an inner port in a two-chamber valve, many air flow configurations may be achieved. For example, as illustrated in FIGS. 20A, 20B, and 22A-L, considering only a single rotor of a two-chamber valve, twelve positions may be achieved between three ports on either an upper or lower half of a valve and an inner port of the valve. Note that these twelve positions include three in which the flow to and from all ports are blocked, resulting in a total of 10 total configurations. As illustrated in FIG. 22A, in a first position, ports 1-3 and the interior port are blocked. As illustrated in FIG. 22B, in a second position, port one is connected to port three while the second and interior ports are blocked. As illustrated in FIG. 22C, in a third position, port one is connected to port three while the second port is connected to the interior port. As illustrated in FIG. 22D, in a fourth position, the first and third ports are blocked while the second port is connected to the interior port. As illustrated in FIG. 22E, in a fifth position, ports 1-3 and the interior port are blocked. As illustrated in FIG. 22F, in a sixth position, the second and third ports are connected while the first and interior ports are blocked. As illustrated in FIG. 22G, in a seventh position, the second and third ports are connected while the first port is connected to the interior port. As illustrated in FIG. 22H, in an eighth position, the first port is connected to the interior port while the second and third ports are blocked. As illustrated in FIG. 22I, in a ninth position, ports 1-3 and the interior port are blocked. As illustrated in FIG. 22J, in a tenth position, the first and second ports are connected while the third and interior ports are blocked. As illustrated in FIG. 22K, in an eleventh position, the first and second ports are connected and the third and interior ports are connected. As illustrated in FIG. 22L, in a twelfth position, the first and second ports are blocked while the third port is connected to the interior port.

While the position diagrams illustrated in the figures show arrows to show connection, it should be appreciated that flow between ports may happen in either direction. The arrows should not be considered as limiting a configuration to a particular direction of flow.

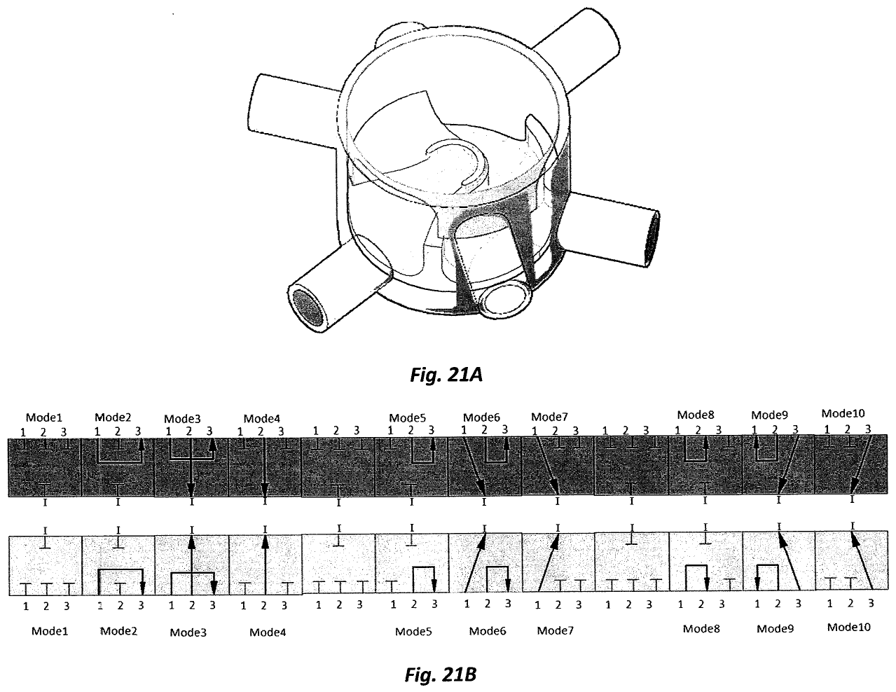

Each of the positions may be achieved by adjusting the angular position of either of the upper and lower rotors. When taking both the upper and lower rotors into consideration, as illustrated in FIGS. 21A and 21B, each of the rotors may be adjusted between the ten total configurations, or modes, achieving a vast number of total configurations for a single two-chamber valve.

As illustrated in FIG. 21B, when a rotor is in a first mode, Mode1, no flow is enabled between any of its ports. For example, if an upper rotor of a two-chamber valve is in Mode1, no flow into or out of the three upper ports of the valve may be possible. Even if the lower rotor is adjusted to direct flow from a lower port into the interior port, the flow will not escape any of the upper ports. Such a mode may be useful to disable flow into or out of any of the upper ports. When an upper rotor and a lower rotor of a two-chamber valve are both in Mode1, no flow into or out of any of the six ports may be possible. This configuration is illustrated in FIG. 22A.

When a rotor is in a second mode, Mode2, no flow is enabled into its second port or the interior port while flow is achieved between the first and third ports. For example, if an upper rotor of a two-chamber valve is in Mode2, flow may be achieved between two of the upper ports while a third is blocked. Even if the lower rotor is adjusted to direct flow from a lower port into the interior port, the flow will not escape any of the upper ports. This configuration is illustrated in FIG. 22B.

When a rotor is in a third mode, Mode3, flow is enabled between the first and third ports and between the second port and the interior port. For example, if an upper rotor of a two-chamber valve is in Mode3, the first and third upper ports will be linked such that flow may be achieved between the first and third upper ports and the second upper port will be opened up to the interior port. Note that flow from the second upper port will only be achieved if the lower rotor is in a position such that one of the lower ports is also opened up to the interior port. This configuration is illustrated in FIG. 22C.

When a rotor is in a fourth mode, Mode4, the second port is opened to the interior port while the first and third ports are blocked. For example, if an upper rotor of a two-chamber valve is in Mode4, the first and third upper ports will be blocked such that flow may not be achieved between the first and third upper ports and the second upper port will be opened up to the interior port. Note that flow from the second upper port will only be achieved if the lower rotor is also in a position such that one of the lower ports is opened up to the interior port. This configuration is illustrated in FIG. 22D.

When a rotor is in a fifth mode, Mode5, the second and third ports are linked via a pathway while the first port is blocked. For example, if an upper rotor of a two-chamber valve is in Mode5, flow may be achieved between two of the upper ports while a third is blocked. Even if the lower rotor is adjusted to direct flow from a lower port into the interior port, the flow will not escape any of the upper ports. This configuration is illustrated in FIG. 22F.

When a rotor is in a sixth mode, Mode6, flow is enabled between the second and third ports and between the first port and the interior port. For example, if an upper rotor of a two-chamber valve is in Mode6, the second and third upper ports will be linked such that flow may be achieved between the second and third upper ports and the first upper port will be opened up to the interior port. Note that flow from the first upper port will only be achieved if the lower rotor is in a position such that one of the lower ports is also opened up to the interior port. This configuration is illustrated in FIG. 22G.

When a rotor is in a seventh mode, Mode7, the first port is opened to the interior port while the second and third ports are blocked. For example, if an upper rotor of a two-chamber valve is in Mode7, the second and third upper ports will be blocked such that flow may not be achieved between the second and third upper ports and the first upper port will be opened up to the interior port. Note that flow from the first upper port will only be achieved if the lower rotor is also in a position such that one of the lower ports is opened up to the interior port. This configuration is illustrated in FIG. 22H.

When a rotor is in an eighth mode, Mode8, the first and second ports are linked via a pathway while the third port is blocked. For example, if an upper rotor of a two-chamber valve is in Mode8, flow may be achieved between two of the upper ports while a third is blocked. Even if the lower rotor is adjusted to direct flow from a lower port into the interior port, the flow will not escape any of the upper ports. This configuration is illustrated in FIG. 22J.

When a rotor is in a ninth mode, Mode9, flow is enabled between the first and second ports and between the third port and the interior port. For example, if an upper rotor of a two-chamber valve is in Mode9, the first and second upper ports will be linked such that flow may be achieved between the first and second upper ports and the third upper port will be opened up to the interior port. Note that flow from the third upper port will only be achieved if the lower rotor is in a position such that one of the lower ports is also opened up to the interior port. This configuration is illustrated in FIG. 22K.

When a rotor is in a tenth mode, Mode10, the third port is opened to the interior port while the first and second ports are blocked. For example, if an upper rotor of a two-chamber valve is in Mode10, the first and second upper ports will be blocked such that flow may not be achieved between the first and second upper ports and the third upper port will be opened up to the interior port. Note that flow from the third upper port will only be achieved if the lower rotor is also in a position such that one of the lower ports is opened up to the interior port. This configuration is illustrated in FIG. 22L.

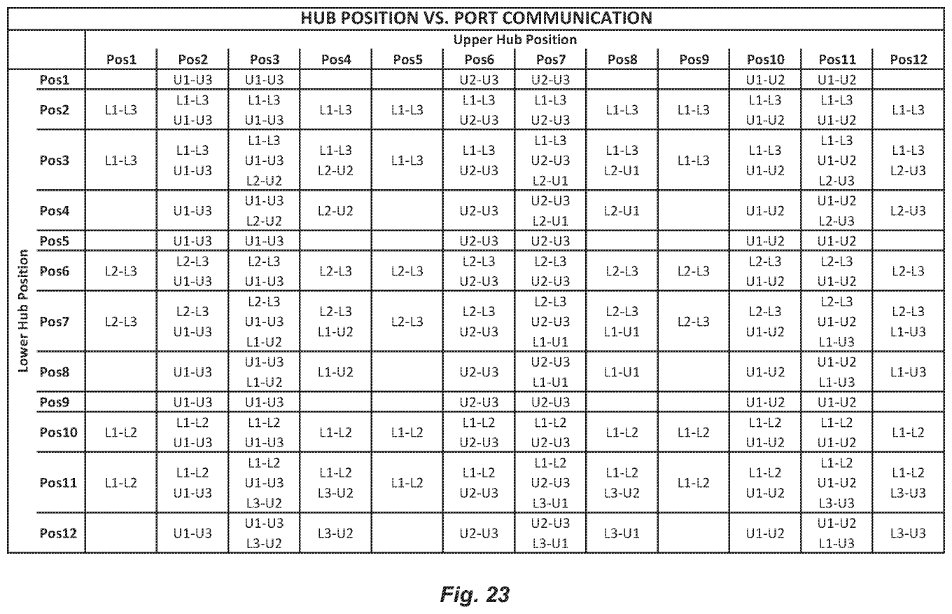

Each of the upper and lower rotors of a two-chamber valve may be independently controlled. By adjusting the angular position of each rotor, a two-chamber valve may be into a variety of configurations. A table providing an overview of possible configurations is illustrated in FIG. 23. As can be appreciated, by adjusting the angular position of the upper and lower rotors a large number of configurations may be achieved. In the table of FIG. 23, an entry is provided for each possible position of the twelve positions (Pos1-Pos12) illustrated in FIG. 20B for each of the two rotors or hubs. Note that positions 1, 5, and 9 (Pos1, Pos5, and Pos9) are functionally equivalent and each results in no flow through the ports associated with the rotor in that position. For example, all entries for the lower hub position being in Pos1, Pos5, and Pos9 are the same and in each entry, no lower port is in a communicative connection with any other port. The ports are referred to by U1, representing upper port 1; U2, representing upper port 2; U3, representing upper port 3; L1, representing lower port 1; L2, representing lower port 2; and L3, representing lower port 3. For example, when the lower rotor is in the seventh position and the upper rotor is in the third position, the second and third lower ports are connected, the first and third upper ports are connected, and the first lower port is in connection with the second upper port.

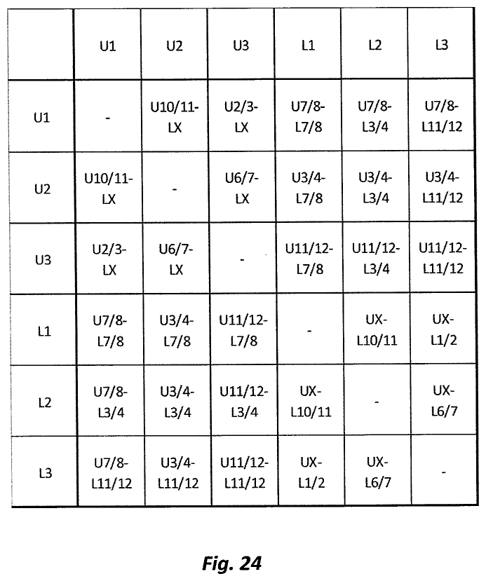

The chart illustrated in FIG. 24 shows possible angular positions to achieve connection between any two ports. In the chart, the top row and the left column represent each of the ports (U1-3 and L1-3). The other fields represent the rotor positions, where for example U6 represented the upper hub or rotor being in pos6 and where UX represents the upper rotor being in any position. For example, for the upper port 1 to be connected to the upper port 2, the upper rotor should be in either position 10 or 11 and the lower rotor may be in any position.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a valve comprising: a housing having a cavity and comprising first, second, third, fourth, fifth, and sixth flow ports, wherein an interior flow port is at a location extending vertically from a center of the housing, wherein the first, second, and third flow ports are at radially spaced apart locations extending horizontally from a lower half of the housing, and wherein the fourth, fifth, and sixth flow ports are at radially spaced apart locations extending horizontally from an upper half of the housing; a first rotatable rotor positioned within a lower half of the cavity about a rotation axis, the first rotor comprising: a first fluid passageway extending from the interior flow port to a first opening at a first outer radial position of a surface of the first rotor; and a second fluid passageway extending through the first rotor between second and third openings at second and third outer radial positions of the surface of the first rotor; and a second rotatable rotor positioned within an upper half of the cavity about the rotation axis, the second rotor comprising: a third fluid passageway extending from the interior flow port to a fourth opening at a first outer radial position of a surface of the second rotor; and a fourth fluid passageway extending through the second rotor between fifth and sixth openings at second and third outer radial positions of the surface of the second rotor.

Aspects of the above valve can include wherein the first, second, and third flow ports are spaced 120 degrees apart from each other.

Aspects of the above valve can include wherein the interior flow port is spaced 90 degrees from each of the first, second, third, fourth, fifth, and sixth flow ports.

Aspects of the above valve can include wherein the first fluid passageway is connected to the third fluid passageway via the interior flow port.

Aspects of the above valve can include wherein the first rotor further comprises two or more sealing faces.

Aspects of the above valve can include wherein the two or more sealing faces are operable to seal one or more of the first, second, and third flow ports depending on a position of the first rotor.

Aspects of the above valve can include wherein the second fluid passageway surrounds a first sealing face of the two or more sealing faces.

Aspects of the above valve can include wherein each of the first and second rotors is rotatably movable to one or more rotor positions.

Aspects of the above valve can include wherein in a first position of the one or more rotor positions: the first passageway allows for flow between the interior flow port and one of the first, second, and third flow ports; the second passageway allows for flow between the other two of the first, second, and third flow ports.

Aspects of the above valve can include wherein in a second position of the one or more rotor positions: the first passageway allows for flow between the interior flow port and one of the first, second, and third flow ports; and one or more of the other two of the second, third, and fourth flow ports is blocked by a sealing face of the first rotor.

Aspects of the above valve can include wherein in a third position of the one or more rotor positions: a sealing face of the first rotor blocks flow to and from one of the first, second, and third flow ports; and the second passageway allows for flow between the other two of the first, second, and third flow ports.

Aspects of the above valve can include wherein in a fourth position of the one or more rotor positions: the first passageway is blocked by a wall of the housing between two of the first, second, and third flow ports, wherein flow to and from the interior flow port is blocked; and two of the first, second, and third flow ports are each blocked by a separate sealing face of the first rotor.

Embodiments include a system, comprising: a processor; a servomotor; and a valve comprising: a housing comprising a cavity and first, second, third, fourth, fifth, and sixth flow ports, wherein an interior flow port is at a location extending vertically from a center of the housing, wherein the first, second, and third flow ports are at radially spaced apart locations extending horizontally from a lower half of the housing, and wherein the fourth, fifth, and sixth flow ports are at radially spaced apart locations extending horizontally from an upper half of the housing; a first rotor positioned within a lower half of the cavity, the rotor being rotatable about a rotation axis and comprising: a first fluid passageway extending from the interior flow port to a first opening at a first outer radial position of a surface of the first rotor; and a second fluid passageway extending through the first rotor between second and third openings at second and third outer radial positions of the surface of the rotor; and a second rotatable rotor positioned within an upper half of the cavity about the rotation axis, the second rotor comprising: a third fluid passageway extending from the interior flow port to a fourth opening at a first outer radial position of a surface of the second rotor; and a fourth fluid passageway extending through the second rotor between fifth and sixth openings at second and third outer radial positions of the surface of the second rotor.

Aspects of the above system can include wherein the first, second, and third flow ports are spaced 120 degrees apart from each other.

Aspects of the above system can include wherein the interior flow port is spaced 90 degrees from each of the first, second, third, fourth, fifth, and sixth flow ports.

Aspects of the above system can include wherein the first fluid passageway is connected to the third fluid passageway via the interior flow port.

Aspects of the above system can include wherein the first rotor further comprises two or more sealing faces.

Aspects of the above system can include wherein the two or more sealing faces are operable to seal one or more of the first, second, and third flow ports depending on a position of the first rotor.

Aspects of the above system can include wherein the second fluid passageway surrounds a first sealing face of the two or more sealing faces.

Aspects of the above system can include wherein each of the first and second rotors is rotatably movable to one or more rotor positions.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A valve comprising:
a housing having a cavity and comprising first, second, third, fourth, fifth, and sixth flow ports, wherein an interior flow port is at a location extending vertically from a center of the housing, wherein the first, second, and third flow ports are at radially spaced apart locations extending horizontally from a lower half of the housing, and wherein the fourth, fifth, and sixth flow ports are at radially spaced apart locations extending horizontally from an upper half of the housing;
a first rotor positioned within a lower half of the cavity and rotatable about a rotation axis, the first rotor comprising:
a first fluid passageway extending from the interior flow port to a first opening at a first outer radial position of a surface of the first rotor; and
a second fluid passageway extending through the first rotor between second and third openings at second and third outer radial positions of the surface of the first rotor; and
a second rotor positioned within an upper half of the cavity and rotatable about the rotation axis, the second rotor comprising:
a third fluid passageway extending from the interior flow port to a fourth opening at a first outer radial position of a surface of the second rotor; and
a fourth fluid passageway extending through the second rotor between fifth and sixth openings at second and third outer radial positions of the surface of the second rotor.

2. The valve of claim 1, wherein the first, second, and third flow ports are spaced 120 degrees apart from each other.

3. The valve of claim 1, wherein the interior flow port is spaced 90 degrees from each of the first, second, third, fourth, fifth, and sixth flow ports.

4. The valve of claim 1, wherein the first fluid passageway is connected to the third fluid passageway via the interior flow port.

5. The valve of claim 1, wherein the first rotor further comprises two or more sealing faces.

6. The valve of claim 5, wherein the two or more sealing faces are operable to seal one or more of the first, second, and third flow ports depending on a position of the first rotor.

7. The valve of claim 5, wherein the second fluid passageway surrounds a first sealing face of the two or more sealing faces.

8. The valve of claim 1, wherein each of the first and second rotors is rotatably movable to one or more rotor positions.

9. The valve of claim 8, wherein in a first position of the one or more rotor positions:
the first passageway allows for flow between the interior flow port and one of the first, second, and third flow ports; and
the second passageway allows for flow between the other two of the first, second, and third flow ports.

10. The valve of claim 9, wherein in a second position of the one or more rotor positions:
the first passageway allows for flow between the interior flow port and one of the first, second, and third flow ports; and
one or more of the other two of the second, third, and fourth flow ports is blocked by a sealing face of the first rotor.

11. The valve of claim 10, wherein in a third position of the one or more rotor positions:
a sealing face of the first rotor blocks flow to and from one of the first, second, and third flow ports; and
the second passageway allows for flow between the other two of the first, second, and third flow ports.

12. The valve of claim 11, wherein in a fourth position of the one or more rotor positions:
the first passageway is blocked by a wall of the housing between two of the first, second, and third flow ports, wherein flow to and from the interior flow port is blocked; and
two of the first, second, and third flow ports are each blocked by a separate sealing face of the first rotor.

13. A system, comprising:
a processor;
a servomotor; and
a valve comprising:
a housing comprising a cavity and first, second, third, fourth, fifth, and sixth flow ports, wherein an interior flow port is at a location extending vertically from a center of the housing, wherein the first, second, and third flow ports are at radially spaced apart locations extending horizontally from a lower half of the housing, and wherein the fourth, fifth, and sixth flow ports are at radially spaced apart locations extending horizontally from an upper half of the housing;
a first rotor positioned within a lower half of the cavity and rotatable about a rotation axis and comprising:
a first fluid passageway extending from the interior flow port to a first opening at a first outer radial position of a surface of the first rotor; and
a second fluid passageway extending through the first rotor between second and third openings at second and third outer radial positions of the surface of the rotor; and
a second rotor positioned within an upper half of the cavity and rotatable about the rotation axis, the second rotor comprising:
a third fluid passageway extending from the interior flow port to a fourth opening at a first outer radial position of a surface of the second rotor; and
a fourth fluid passageway extending through the second rotor between fifth and sixth openings at second and third outer radial positions of the surface of the second rotor,
wherein the processor is configured to control the first and second rotors via the servomotor.

14. The system of claim 13, wherein the first, second, and third flow ports are spaced 120 degrees apart from each other.

15. The system of claim 13, wherein the interior flow port is spaced 90 degrees from each of the first, second, third, fourth, fifth, and sixth flow ports.

16. The system of claim 13, wherein the first fluid passageway is connected to the third fluid passageway via the interior flow port.

17. The system of claim 13, wherein the first rotor further comprises two or more sealing faces.

18. The system of claim 17, wherein the two or more sealing faces are operable to seal one or more of the first, second, and third flow ports depending on a position of the first rotor.

19. The system of claim 17, wherein the second fluid passageway surrounds a first sealing face of the two or more sealing faces.

20. A vehicle comprising:
a plurality of tubes connected to a valve, the valve comprising:
a housing comprising a cavity and first, second, third, fourth, fifth, and sixth flow ports, wherein an interior flow port is at a location extending vertically from a center of the housing, wherein the first, second, and third flow ports are at radially spaced apart locations extending horizontally from a lower half of the housing, and wherein the fourth, fifth, and sixth flow ports are at radially spaced apart locations extending horizontally from an upper half of the housing;
a first rotor positioned within a lower half of the cavity and being rotatable about a rotation axis and comprising:
a first fluid passageway extending from the interior flow port to a first opening at a first outer radial position of a surface of the first rotor; and
a second fluid passageway extending through the first rotor between second and third openings at second and third outer radial positions of the surface of the rotor; and
a second rotor positioned within an upper half of the cavity and being rotatable about the rotation axis, the second rotor comprising:
a third fluid passageway extending from the interior flow port to a fourth opening at a first outer radial position of a surface of the second rotor; and
a fourth fluid passageway extending through the second rotor between fifth and sixth openings at second and third outer radial positions of the surface of the second rotor.
